(19) United States
(12) Patent Application Publication
(10) Pub. No.: US 2017/0178847 A1
(43) Pub. Date: Jun. 22, 2017

(54) ARC ENERGY REDUCTION METHOD AND APPARATUS FOR MULTI-PHASE SWITCHING DEVICES

(71) Applicant: SCHNEIDER ELECTRIC USA, INC., Schaumburg, IL (US)

(72) Inventors: Kevin M. Jefferies, Raleigh, NC (US); Benjamin W. Edwards, Rolesville, NC (US); Matthew L. White, Raleigh, NC (US); Alan Freeman, Raleigh, NC (US); Richard Karl Weiler, Wake Forest, NC (US)

(73) Assignee: SCHNEIDER ELETRIC USA, INC., Schaumburg, IL (US)

(21) Appl. No.: 14/976,098

(22) Filed: Dec. 21, 2015

(51) Int. Cl. H01H 47/00; H01H 47/22

(52) U.S. Cl. CPC H01H 47/002; H01H 47/223

(57) ABSTRACT

A three phase switching device and method for reducing arc energy and contact erosion during the opening and closing of electrical contacts, the device having one electromagnet and one armature. The device and method permits the closing of all three phases at calculated target points immediately prior to their current zero crossing by controlling the velocity at which the armature travels during the opening and closing process.

### FIELD OF THE INVENTION

The invention is generally directed to arc energy reduction and particularly to arc energy reduction in three phase electromagnetically operated switching devices.

### BACKGROUND OF THE INVENTION

Electrical contacts in multi-phase switching devices, such as three phase contactors, are exposed to the total arc energy dissipated over the lifetime of the switching device. Therefore, the life of the switching device is greatly determined by the amount of arcing occurring during each closing and opening of the contacts. Methods to reduce the total arc energy dissipated by the contact are beneficial in this regard. The less energy the contact is required to dissipate, the less erosion of contact material occurs. This can increase the life expectancy of the contact, and/or reduced the contact cost through contact material reduction. In three-phase devices, the arcing contact erosion of each individual phase's contact set must be considered.

It is well known that opening an alternating current (AC) electric circuit at the point when its current passes through the zero crossing point of the positive and negative current cycles will significantly reduce arcing. For many years three phase electromagnetically operated switching devices, such as a contactor, have opened all three phases at the same time, regardless of where the phases were with respect to their zero crossing, which produced significant arcing. Contactor construction has generally remained the same since they were first invented. The contactor includes an armature which is normally biased to an extended position and movable to a retracted position when power is applied to the electromagnetic coil of the contactor. Typically a contactor armature is attached to a contact carrier which supports three movable contacts, one for each phase of the three phase power supply. The three movable contacts are moved by the armature into contact with three stationary contacts when power is applied to the magnetic coil. When power is removed from the magnetic coil the armature is biased to its extended position wherein the three movable contacts separate almost simultaneously from the three stationary contacts. Since the contactor opens all three contacts essentially at the same time it is certain that at least two phases will open at non-zero current, and likely that all three will open at non-zero current. Therefore significant arcing at the contacts results.

First attempts at reducing contact arcing attempted to calculate, using a controller monitoring the current wave forms, when one phase was approaching its lowest current level and triggering the contactor to open as close as possible to that point. If the calculation was accurate it would reduce the arcing in that one phase, but the other two phases would still produce significant arcing since they would be opening at higher current levels.

Attempts to further reduce arcing have employed fixed mechanical time delays in opening the second and third contacts such that they would open closer to their minimum current levels. The fixed mechanical time delay is accomplished by offsetting one contact with respect to the other two contacts. The mechanical time delay is determined by the length of the offset and the velocity at which the biasing spring opens the contacts after power is removed from the electromagnet. If the offset distance and biasing spring force are accurately determined it can initially reduce arcing in the second and third contacts. However, manufacturing tolerances and slight differences from one batch of parts to another or one supplier to another can affect the timing between the first contact opening and the second and third contacts opening. Even if the initial timing is accurate, over time the second and third contacts will begin to erode at a faster rate than the first contact, which has a controlled opening based on the monitored current wave form. Also any change in the contact thickness will affect the timing of the second and third contact opening. As the contact erosion increases the mechanical time delay between the first contact opening and the second and third contacts opening will decrease causing the second and third contacts to open a higher current. More arcing and even faster erosion for the second and third contacts will result in a shorter life for the switching device.

In more recent attempts each electrical phase has a controller for monitoring its current wave form and a switching device for opening and closing its contact at its lowest current level. Although this does significantly reduce arcing it also significantly increases the cost of a three phase switching device. Therefore, it would be desirable to develop a three phase switching device employing the original less expensive single controller, single electromagnet and armature design that could reduce the arcing level to a point generally equivalent to the three controller, three switching device level and have the ability to compensate for manufacturing tolerances, lot and vendor differences, current frequency differences, friction and part degradation to extend contact life of the switching device.

### SUMMARY OF THE INVENTION

The present invention provides a three phase switching device and method for significantly reducing contact arcing during the opening of three phase circuits and extending contact life by opening the contacts at calculated target points immediately prior to the current zero crossing of all three phases. The switching device and method also compensates for contact erosion over the life of the switching device.

The present invention provides a method for reducing arc energy and contact erosion of a three phase switching device comprising the steps of:
monitoring, by a control/monitoring circuit, electrical characteristics of a three phase electrical system;
detecting, by the control/monitoring circuit, a reference point for a first opening phase;
determining, by the control/monitoring circuit, a first target point on a wave form of the first opening phase and a trigger point for initiating the opening of the first opening phase precisely at the first target point;
determining, by the control/monitoring circuit, a second target point for a second and third opening phases;
initiating, by the control monitoring circuit, an opening signal to the switching device in response to detecting the trigger point;
adjusting, by a coil power circuit, a velocity of an armature of the switching device such that the second and third opening phases open precisely at the second target point.

The present invention also provides a three phase electromagnetic switching system that reduces arc energy and contact erosion comprising:
an electromagnet having a coil and an armature, the armature being movable between a first position when the coil is energized and second position when the coil is de-energized, the armature supporting three bridging contacts, each bridging contact being associated with one of three electrical phases of a three phase power source;
a control/monitoring circuit, for monitoring characteristics of the three phase power source, determining a first target point for a first opening phase, a first trigger point for initiating the opening of the first opening phase such that the first opening phase will open precisely at the first target point, and a second target point for a second and third simultaneously opening phases; and
a coil power circuit providing a pulse width modulated signal to the coil such that the velocity of the armature can be adjusted to ensure that the second and third simultaneously opening phase open precisely at the second target point.

### BRIEF DESCRIPTION OF THE DRAWINGS

FIG. 1 illustrates the electromagnetic contactor of the present invention in the first position.

FIG. 2 illustrates the electromagnetic contactor of the present invention in the second position.

FIG. 3 illustrates a current wave form for the controlled opening of three phase contacts according to the present invention.

FIG. 4 is a flow chart of the algorithm for opening a three phase circuit according to the current wave form of FIG. 3.

FIG. 5 illustrates a first embodiment of a coil power circuit providing power to the coil of the contactor's electromagnet.

FIG. 6 illustrates a second embodiment of a coil power circuit providing power to the coil of the contactor's electromagnet.

### DETAILED DESCRIPTION OF THE EXAMPLE EMBODIMENTS

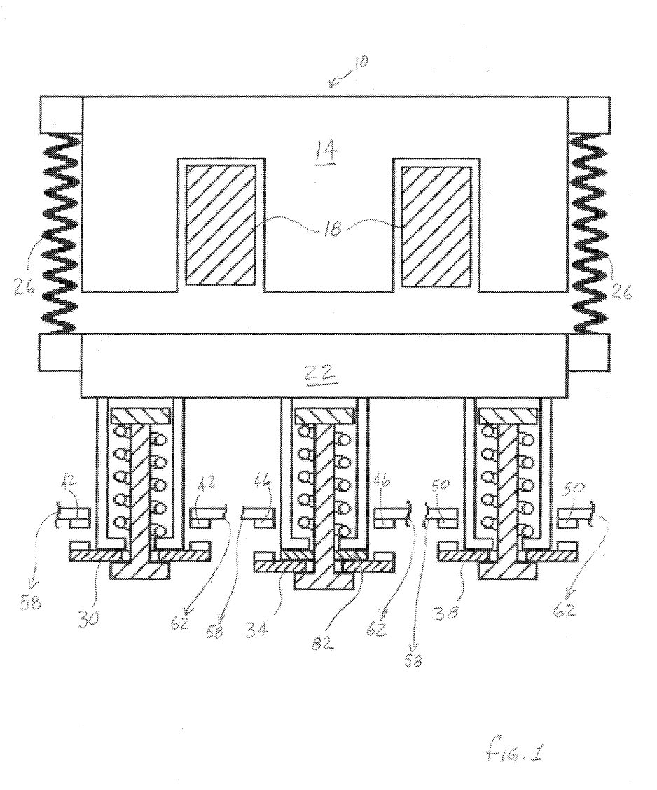

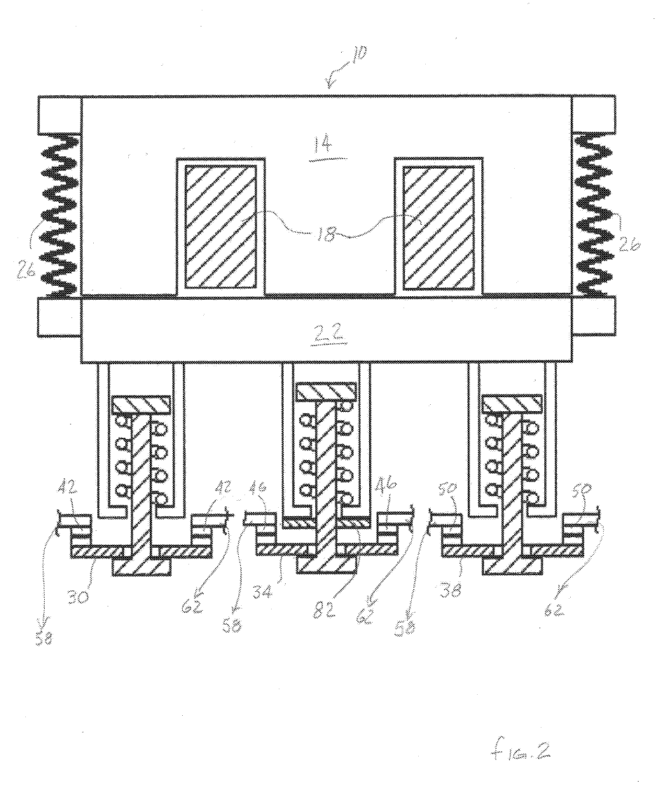

The present invention provides a switching device method of reducing the arcing energy resulting from the opening and closing of three phase electrical contacts. FIG. 1 illustrates a three phase electromagnetic switching device of the present invention, generally known as a contactor and indicated by reference numeral 10. The contactor 10 comprises an electromagnet 14, having a coil 18, an armature 22, biasing springs 26, movable bridging contacts 30, 34 and 38 and fixed contacts 42, 46 and 50. The electromagnet 14 produces a magnetic field when the coil 18 is energized by a coil power circuit 54 and does not produce a magnetic field when the coil 18 is de-energized. The armature 22, being movable between a first position to which the armature 22 is biased by biasing springs 26 when the coil 18 is de-energized (FIG. 1) and a second position when the coil 18 is energized by the coil power circuit 54 and the resulting magnetic field overcomes the force of the biasing springs 26, thereby pulling the armature 22 into contact with the electromagnet 14 (FIG. 2). The armature 22 supports the three movable bridging contacts 30, 34 and 38, which move between first and second positions as the armature 22 moves between its first and second positions. As can be seen in FIG. 1, the bridging contacts 30, 34 and 38 are spaced apart from fixed contacts 42, 46 and 50, respectively. In FIG. 2, bridging contacts 30, 34 and 38 are in physical contact with fixed contacts 42, 46 and 50, respectively. Fixed contacts 42, 46 and 50, are in spaced apart pairs such that one of each pair is connected to one phase of the three phase power source 58 and the other of each pair is connected to a load 62. Therefore, when the armature is in its first position no power is supplied to the load 62 and in its second position power is supplied to the load 62. As the bridging contacts 30, 34 and 38 make or break contact with the fixed contacts 42, 46 and 50, respectively, an electric arc is produced. Since the intensity of the electrical arc, and contact erosion caused by the arcing, is directly related to the magnitude of the current the bridging contacts 30, 34 and 38 are making or breaking, it is important to precisely control the point on the current wave form at which all three bridging contacts 30, 34 and 38 make or break current over the life of the contactor 10.

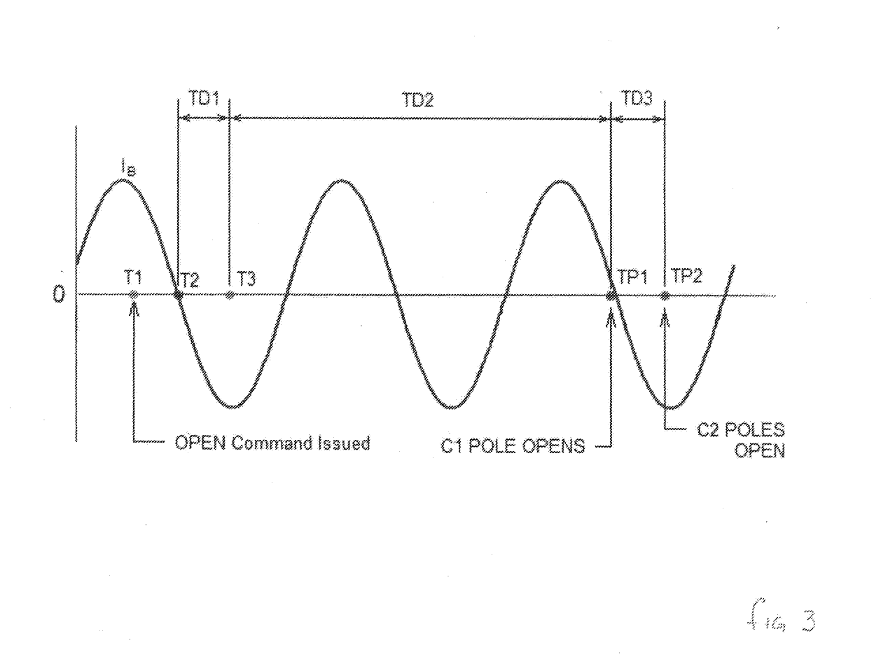

FIG. 3 illustrates graphically the method of the present invention for opening a three phase electrical circuit while producing minimal arcing and erosion of contacts 30, 34, 38, 42, 46 and 50. The method comprises opening one phase of a three phase power source 58 at a first calculated target point TP1 immediately prior to its current wave form passing through its zero-crossing, and opening the two remaining phases, whose current will become symmetrical but opposite in polarity, at a second calculated target point TP2 immediately prior to them simultaneously passing through their zero-crossing. To accomplish this two-stage opening a mechanical advantage 82, as shown in FIG. 1, is provided to the first bridging contact to open, in this illustration bridging contact 34. The mechanical advantage 82 merely insures that the second and third phase bridging contacts, 30 and 38 respectively, open after the first phase bridging contact 34 opens at first target point TP1. At time T1 a request to open the three phase circuit is initiated. At time T2 the current wave form of the first phase to be opened passes through its zero crossing. The zero corssing at time T2 is the reference point for calculating first target point TP1, the electrical angle (trigger point) at which to initiate the opening of armature 22, second target point TP2 and the velocity at which armature 22 must travel between first target point TP1 and second target point TP2 (approximately 90 electrical degrees for a motor load 62) to ensure that the second and third phases contacts, 30 and 38 respectively, open precisely at second target point TP2. The trigger point can be determined by the armature 22 travel between bridging contact 34 and bridging contacts 30 and 38, the type of load 62 being switched and the inherent acceleration profile of the armature 22. Time T3, and its associated point on the current wave form of the first phase to open, is the calculated trigger point at which the command to open armature 22 must be given for the first phase bridging contact 34 to open precisely at first target point TP1. This calculation can be the difference between a determined non-integer number of half cycles between the trigger point at time T3 and the first target TP1 rounded up to the next integer number of half cycles minus the integer number of half cycles between the reference point at time T2 and the first target point TP1. The determined non-integer number of half cycles between the trigger point at time T3 and the first target TP1 previously stored design test or historic data stored in a memory 66 of a control monitoring circuit 70. After the trigger signal has been issued at time T3, controlling the opening velocity of armature 22 begins for the second and third phase bridging contacts, 34 and 38 respectively, to open precisely at second target point TP2. First target point TP1 and second target point TP2 are generally between 5 electrical degrees before the current zero crossing and the current zero crossing.

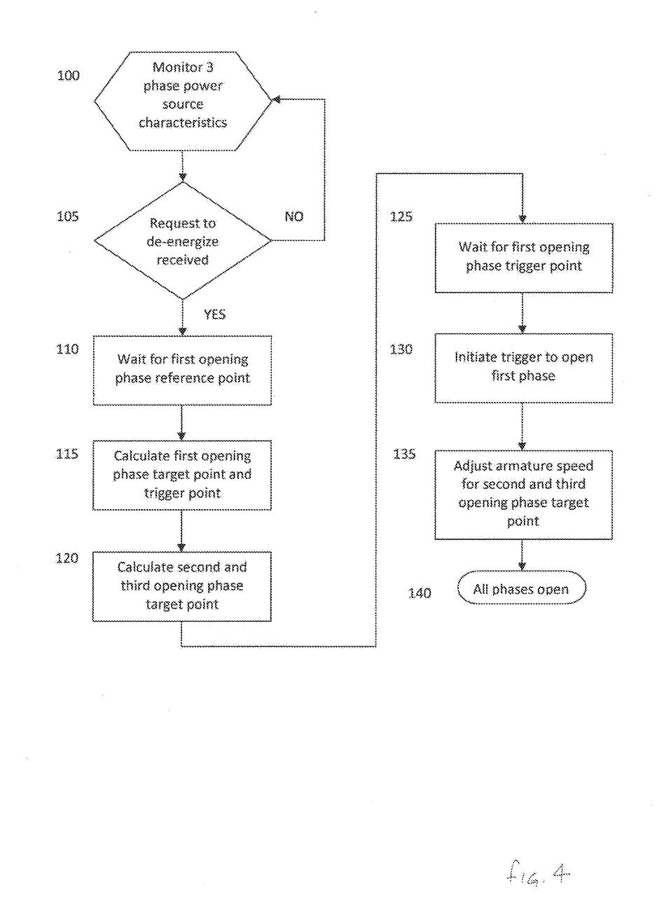

FIG. 4 is a flow chart for an algorithm 74 used by a processor 78 to determine the target points TP1 and TP2, trigger point and adjust the armature 22 velocity such that the contactor can accurately open all three phases of the three phase power source 58 at their target points, TP1 and TP2, while producing minimal arcing between the bridging contacts 30, 34 and 38 and fixed contacts 42, 46 and 50, respectively. The processor 78 and a memory 66, in which the algorithm 74 is stored, are part of a control/monitoring circuit 70. The control/monitoring circuit 70 monitors the three phase power source 58 at step 100. At step 105 the control/monitoring circuit 70 receives a request to de-energize the three phase power. At step 110 the control/monitoring circuit 70 is waiting for the first opening phase to pass through its zero crossing, which is a reference point for calculating the first opening phase target point TP1 and trigger point at step 115. At step 120 the processor 78 is waiting for the trigger point and also calculating a second target point TP2 for the second and third phases to open at step 125. At step 130 the trigger point for the first opening phase is reached and the processor 78 initiates opening of the contactor 10. At step 135, immediately following step 130, the processor 78 begins adjusting the velocity of armature 22 such that the second and third phase contacts, 34 and 38 respectively, open precisely at the second target point. At step 140 the second target point is reached and all contacts are open.

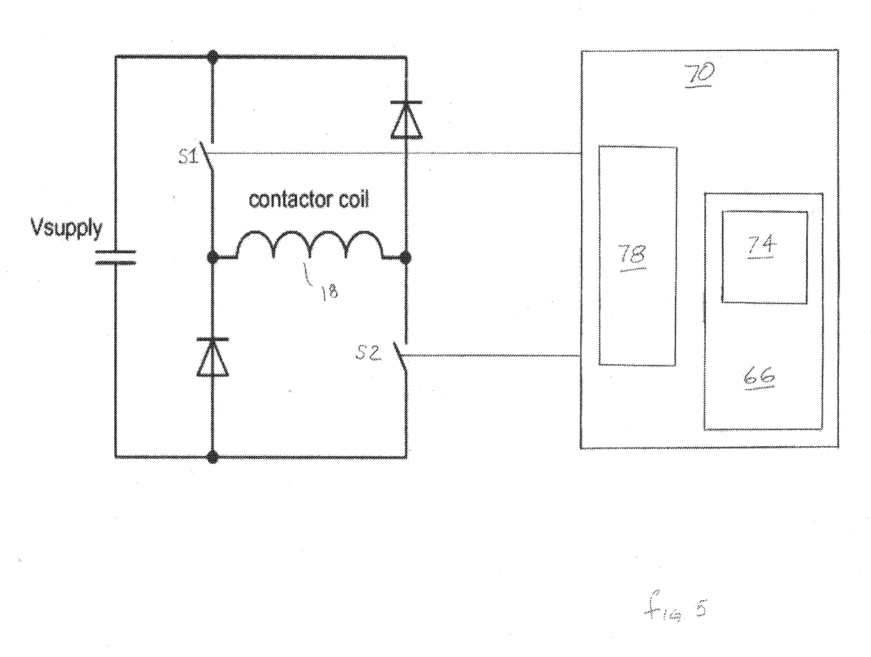

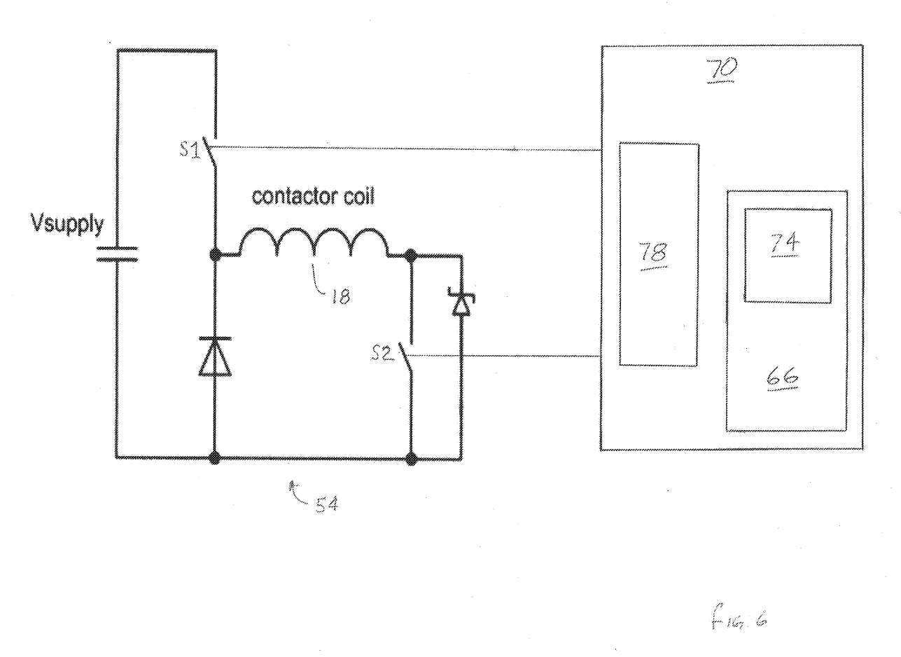

Controlling the velocity of armature 22 is accomplished by providing a pulse width modulated (PWM) current to the coil 18 of the contactor's 10 electromagnet 14. Switches S1 and S2 in the coil power circuits 54 of FIGS. 5 and 6 are opened and closed at a duty cycle determined by the processor 78. With a high duty cycle the electromagnet 14 produces a stronger magnetic field which provides a stronger attraction to the armature 22 resulting in a slower armature 22 opening velocity. A lower duty cycle produces a weaker magnetic field with weaker attraction to the armature and results in a faster armature 22 opening velocity. The maximum armature 22 opening velocity is provided by the biasing springs 26 when little or no current is applied to the coil 18.

By controlling the armature 22 velocity other issues such as 50/60 Hz power systems, manufacturing variations and various load 62 characteristics can be compensated for. The process can basically be reversed and used for closing bridging contacts 30, 34 and 38 to power a load 62.

We claim:

1. A method for reducing arc energy and contact erosion in a three phase electromagnetic switching device comprising the steps of:
monitoring, by a control/monitoring circuit, electrical characteristics of a three phase electrical system;
detecting, by the control/monitoring circuit, a reference point for a first opening phase;
determining, by the control/monitoring circuit, a first target point on a wave form of the first opening phase and a trigger point for initiating the opening of the first opening phase precisely at the first target point;
determining, by the control/monitoring circuit, a second target point for a second and third opening phases;
initiating, by the control monitoring circuit, an opening signal to the switching device in response to detecting the trigger point;
adjusting, by a coil power circuit, a velocity of an armature of the three phase switching device such that the second and third opening phases open precisely at the second target point.

2. The method of claim 1, wherein the reference point is a zero crossing of the current wave form of the first opening phase.

3. The method of claim 1, wherein first target point is a selected integer number of half cycles after the reference point.

4. The method of claim 1, wherein the trigger point is calculated from the reference point and the first target point.

5. The method of claim 1, wherein first target point is a point immediately prior to the zero crossing of wave form of the first opening phase.

6. The method of claim 1, wherein the second target point is a determined number of electrical degrees after the first target point.

7. The method of claim 6, wherein the second target point is a number of electrical degrees after the first target point at least partially determined by a load being disconnected by the three phase switching device.

8. The method of claim 1, wherein the second target point is approximately 90 electrical degrees after the first target point for a motor load.

9. The method of claim 1, wherein the coil power circuit provides a pulse width modulated signal to a coil of the electromagnet to adjust a strength of a magnetic field produced by the electromagnet.

10. The method of claim 9, wherein the magnetic field strength is determined by the control/monitoring circuit.

12. The method of claim 9, wherein the duty cycle of the pulse width modulated signal is determined by the control/monitoring circuit.

13. The method of claim 1, wherein the armature supports three bridging contacts.

14. The method of claim 13, wherein the first opening phase has a mechanical advantage to open prior to the second and third opening phases.

15. A three phase electromagnetic switching system that reduces arc energy and contact erosion comprising:
an electromagnet having a coil and an armature, the armature being movable between a first position when the coil is energized and second position when the coil is de-energized, the armature supporting three bridging contacts, each bridging contact being associated with one of three electrical phases of a three phase power source;
a control/monitoring circuit, for monitoring characteristics of the three phase power source, determining a first target point for a first opening phase, a first trigger point for initiating the opening of the first opening phase such that the first opening phase will open precisely at the first target point, and a second target point for a second and third simultaneously opening phases; and
a coil power circuit providing a pulse width modulated signal to the coil such that the velocity of the armature can be adjusted to ensure that the second and third simultaneously opening phases open precisely at the second target point.

16. The three phase electromagnetic switching system of claim 15, wherein the control/monitoring circuit includes a memory for storing algorithms used to determine the first and second target points, the first trigger point and to control the duty cycle of the pulse width modulated coil signal and a processor to implement the algorithms.

17. The three phase electromagnetic switching system of claim 16, wherein a high duty cycle produces a slower armature velocity and a low duty cycle produces a higher armature velocity.

18. The three phase electromagnetic switching system of claim 15, wherein the bridging contact of the first opening phase has a mechanical advantage to open before the second and third simultaneously opening phases
